(19) United States
(12) Patent Application Publication
(10) Pub. No.: US 2009/0083309 A1
(43) Pub. Date: Mar. 26, 2009

(54) Credential Production Job Management

(75) Inventors: Kelly R. Nehowig, Maple Grove, MN (US); David T. Gale, Champlin, MN (US); Keith A. Platfoot, Rosewell, GA (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: Fargo Electronics, Inc., Eden Prairie, MN (US)

(21) Appl. No.: 12/042,167

(22) Filed: Mar. 4, 2008

Related U.S. Application Data
(60) Provisional application No. 60/974,259, filed on Sep. 21, 2007.

(51) Int. Cl. G06F 17/30

(52) U.S. Cl. 707/102

(57) ABSTRACT

One embodiment of a credential production system includes a plurality of credential manufacturing devices, at least one client computer and a credential production server that is remote from the client computer and the credential manufacturing device. The credential production server comprises instructions stored in a tangible medium and executable by a microprocessor for receiving a credential production job from one of the client computers at the credential production server, wherein the credential production job identifies a credential manufacturing device model, selecting a final candidate credential manufacturing device among the plurality of credential manufacturing devices having a model that matches the model identified in the credential production job, and sending the credential production job to the final candidate credential manufacturing device for processing. Another embodiment is directed to a method of managing credential production jobs in a credential production system.

This claims the benefit U.S. Provisional Application Ser. No. 60/974,259, filed Sep. 21, 2007, which is incorporated herein by reference in its entirety.

### BACKGROUND

Credentials include identification cards, driver's licenses, passports, and other documents. Such credentials are formed from credential substrates including paper substrates, plastic substrates, cards and other materials. Credentials generally include printed information, such as a photo, account numbers, identification numbers, and other personal information. A secure overlaminate may also be laminated to the surfaces of the credential substrate to protect the surfaces from damage and, in some instances, provide a security feature (e.g., hologram). Additionally, credentials can include data that is encoded in a smartcard chip, a magnetic stripe, or a barcode, for example.

Credential manufacturing devices process credential substrates to complete at least a portion of the final credential. Exemplary processes performed by credential manufacturing devices include printing images on one or more surfaces of the credential substrate, laminating an overlaminate film to a surface of the credential substrate, writing or encoding data to the credential substrate, and other processes. Exemplary credential substrate processing components configured to perform these processes include a print head, a laminating roller, and a data writer or data encoding device.

Credential manufacturing devices can be coupled to a network for communication with other computers on the network. In such an arrangement, a client computer on the network can directly communicate with the networked Credential manufacturing devices. This allows the client to directly communicate credential production jobs to the credential manufacturing devices on the network.

Unfortunately, such a direct link to networked Credential manufacturing devices does cannot generally provide the level of security that is desired for some uses of credential manufacturing devices. For example, it is often desirable to limit access to credential manufacturing devices, such as identification card manufacturing devices, in order to reduce the likelihood of unauthorized credential production.

Embodiments of the present invention provide solutions to these and other problems, and offer other advantages over the prior art.

### SUMMARY

Embodiments are directed to credential production systems and methods for managing credential production jobs in a credential production system. One embodiment of the credential production system includes a plurality of credential manufacturing devices, at least one client computer and a credential production server that is remote from the client computer and the credential manufacturing device. The credential production server comprises instructions stored in a tangible medium and executable by a microprocessor for receiving a credential production job from one of the client computers at the credential production server, wherein the credential production job identifies a credential manufacturing device model name, selecting a final candidate credential manufacturing device among the plurality of credential manufacturing devices having a model name that matches the model name identified in the credential production job, and sending the credential production job to the final candidate credential manufacturing device for processing.

One embodiment of the method is directed to managing credential production jobs in a credential production system that comprises a plurality of client computers, a plurality of credential manufacturing devices, and a credential production server that is remote from the client computers and the credential manufacturing devices. In the method, a credential production job from one of the client computers is received at the credential production server, wherein the credential production job identifies a credential manufacturing device model name. A final candidate credential manufacturing device is selected among the plurality of credential manufacturing devices having a model name that matches the model name identified in the credential production job. The credential production job is then sent to the final candidate credential manufacturing device and a credential substrate is processed using the final candidate credential manufacturing device in accordance with the credential production job.

Other features and benefits that characterize embodiments of the present invention will be apparent upon reading the following detailed description and review of the associated drawings.

### BRIEF DESCRIPTION OF THE DRAWINGS

FIG. 1 is a simplified diagram of a credential manufacturing system in accordance with embodiments of the invention.

FIG. 2 is a simplified diagram of a credential manufacturing device in accordance with embodiments of the invention.

FIG. 3 is a simplified diagram of a print head in accordance with embodiments of the invention.

FIG. 4 is a simplified diagram of a laminator in accordance with embodiments of the invention.

FIG. 5 is a simplified diagram of a data writer in accordance with embodiments of the invention.

FIG. 6 is a simplified diagram of a substrate rotator in accordance with embodiments of the invention.

FIG. 7 is a flowchart illustrating a method of managing credential production jobs in accordance with embodiments of the invention.

FIG. 8 is a flowchart illustrating a method of selecting a final candidate credential manufacturing device in accordance with embodiments of the invention.

FIGS. 9 and 10 are a flowcharts illustrating methods of managing credential manufacturing device information in accordance with embodiments of the invention.

### DETAILED DESCRIPTION OF ILLUSTRATIVE EMBODIMENTS

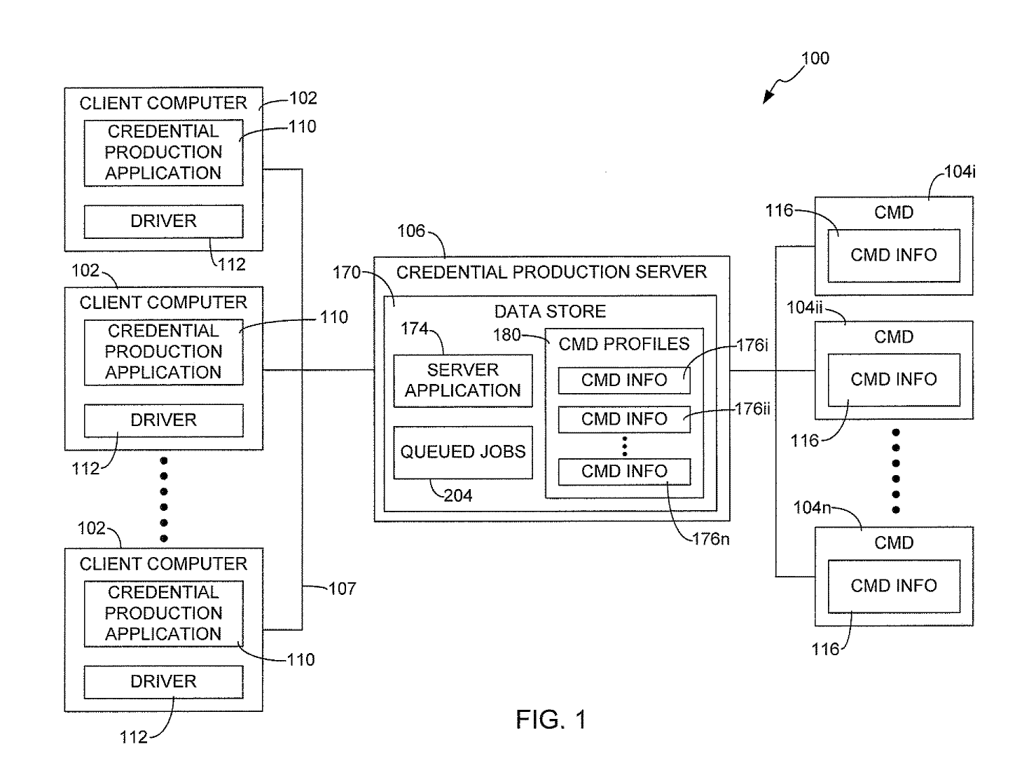

Embodiments of the present invention are directed to systems and methods for managing credential manufacturing device information and credential production jobs. FIG. 1 is a simplified diagram of a credential manufacturing system 100 in accordance with embodiments of the invention. Embodiments of the system 100 include one or more client computers 102, one or more credential manufacturing devices, generally identified as 104, and a credential production server 106. Embodiments of the invention are designed to be practiced in distributed computing environments where tasks are performed by remote processing devices, such as the client computer 102, the credential manufacturing devices 104 and the server 106, that are linked through a data communications network, which is represented by communication links 107 and 108.

Embodiments of the invention may be described in the general context of applications or programs, which comprise computer or microprocessor-executable instructions stored in a tangible computer-readable medium. Generally, program modules or applications include routines, programs, objects, components, data structures, etc. that perform particular tasks (i.e., method steps) or implement particular abstract data types.

In accordance with one embodiment, the client computers 102 host or provide user access to a credential production application 110, which is used to design a credential product, such as an identification card. The credential production application 110 produces credential production jobs that, once processed by a driver program 112, can be processed by one of the credential manufacturing devices 104 to produce the desired credential.

In accordance with conventional methods, a user executes a command to have a particular credential manufacturing device process the credential production job. A driver program for the selected credential manufacturing device encodes the processing instructions of the credential production job in accordance with the requirements of the credential manufacturing device. This reduces the processing power required of the credential manufacturing devices and speeds up the processing of the credential production job at the credential manufacturing device.

For example, a credential production job for an identification card may include an image that is to be printed by the credential manufacturing device on to a plastic card substrate. The conventional driver program encodes the credential production job, in part, by rastorizing the image into image data, such as a *.prn file that identifies the cyan, magenta, yellow and black overlaid images that, when printed on the substrate, will form the desired image. The image data is in a format that is generally in accordance with the type or model of credential manufacturing device that is to process the credential production job. That is, different models of credential manufacturing devices require different formats for the image data so that the image can be properly printed to the substrate.

The conventional driver program may also format other substrate processing instructions of the credential production job in accordance with the particular model name of credential manufacturing device that is to process the credential production job and/or the processing devices (e.g., data writer, substrate rotator, substrate laminator, etc.) of the credential manufacturing device. Such processing instructions include, for example, data writing or encoding instructions, substrate inversion instructions and laminating instructions.

The credential production job, after being processed by the conventional driver program, is then sent directly to the designated credential manufacturing device typically using a direct or a network communication link. The credential manufacturing device then processes the credential production job to produce the credential.

In accordance with one embodiment of the invention, the driver programs 112 of the client computers 102 operate differently than the conventional driver programs described above. In one embodiment, the driver programs 112 are each configured to encapsulate the credential production job within a data file that is decipherable by the server 106, but not the individual credential manufacturing devices 104. The term “credential production job” will generally be used to describe the form of the credential production job after processing by the driver program 112. Accordingly, rather than being sent directly to one of the credential manufacturing devices 104 for processing, the credential production job is sent to the server 106.

One embodiment of the credential production job includes an identification of the type or model name of the credential manufacturing device 104 that is at least in the category of credential manufacturing devices that are configured to process the credential production job. This is necessary due to format differences that must be accommodated from one model credential manufacturing device 104 to another. In other words, a credential production job that has been created for one model of credential manufacturing device 104 cannot be properly processed by a credential manufacturing device of another model.

Thus, while the “model name” as used herein in the credential production job identifies a particular model of credential manufacturing device 104 in the system 100, the model name identified in the credential production job does not identify a particular credential manufacturing device 104 on the network or in the system 100. This use of the model name is distinguishable from conventional networked credential manufacturing devices that are each identified on the network by a name. For example, if one selects a conventional driver program for a printer on the network that may be identified by its model, the print job will be sent directly to the selected printer, as mentioned above. Unlike this practice, one embodiment of the invention uses of the model name in the credential production job not to specify a particular credential manufacturing device to which jobs will be sent, but only to specify the particular model of credential manufacturing device 104 that is to receive the job. As a result, it should be understood that the model name or number identified in the credential production job of the present invention is being used in a different manner than as an identifier of a particular device.

In one exemplary embodiment, the credential production jobs output by the driver programs 112 are encapsulated in a data file that is in the Extensible Markup Language (XML) format. In one exemplary embodiment, the credential production job includes header information and raw data. The header information contains information that identifies the model of credential manufacturing device 104 that the job has been prepared for, the hardware requirements (e.g., processing devices, ribbon type, etc.) that are required to process the job and/or other information, for example. As will be explained below, such information can be used by the server to direct the credential production job to an appropriate credential manufacturing device 104 for processing. The raw data includes the image data, encoding data and/or other data relating to the job.

In one embodiment, the driver program 112 sends the credential production job to the server 106, as opposed to directly to any one of the credential manufacturing devices 104 of the system 100, using a suitable data communication method, such as a network communication technique. In one exemplary embodiment, the driver program 112 sends the credential production job to the server by opening a Transmission Control Protocol (TCP) socket to the server 106, which has an address that is the Internet Protocol (IP) address of the server. Other data communication methods can also be used.

The use of the model name in the credential production job provides a relatively generic identification of the credential manufacturing device 104 that is to be used to process the credential production job. This allows the driver program 112 to be used to designate a group of credential manufacturing devices 104 having the same model name. As will be describe below in greater detail, embodiments relate to the server 106 using the information provided in the credential production job generated by the driver program 112, such as the model name, to manage the credential production jobs including distributing the credential production jobs to particular credential manufacturing devices 104 within a group.

In accordance with another embodiment, the driver program 112 corresponds to an individual credential manufacturing device 104 and the driver program 112 allows a user to access credential manufacturing device information (e.g., “properties”), generally referred to as 116, relating to each of the credential manufacturing devices 104, such as through a conventional graphical user interface. Exemplary credential manufacturing device information 116 includes the status of the credential manufacturing device 104, information regarding a print ribbon (e.g., ribbon type, remaining prints, etc.) used in the credential manufacturing device 104, information regarding an overlaminate film (e.g., overlaminate type, remaining overlaminate, etc.) used in the credential manufacturing device, information regarding substrates (e.g., card type, remaining cards, etc.) used in the credential manufacturing device, processes (e.g., substrate inversion, substrate lamination, substrate data writing, etc.) that the credential manufacturing device is capable of performing, the hardware components or processing devices (e.g., substrate rotator, laminator, data writer, print head, etc.) of the credential manufacturing device and other information relating to the credential manufacturing device corresponding to the driver program 11 2. Some of the above-described information relating to the consumable supplies, such as the print ribbon, the overlaminate film or ribbon and substrate supplies, can be obtained directly from memories of the supplies, such as from radio frequency identification (RFID) tags coupled to the supplies.

However, as will be discussed below in greater detail, unlike conventional driver programs that communicate directly with the credential manufacturing device to which they relate to retrieve the credential manufacturing device information, one embodiment of the driver program 112 only communicates with the server 106. That is, requests for credential manufacturing device information sent from the driver program 112 of a client computer 102 are routed directly to the server 106, which responds to the request by sending the credential manufacturing device information back to the client computer. The communication of the request for credential manufacturing device information generated by the driver program 112 can be performed in accordance with the method described above with regard to the credential production job or other suitable data communication technique with the server 106.

The credential manufacturing devices 104 are configured to process credential substrates in accordance with the credential production job to form a desired credential, such as an identification card, a credit card, a passport or other credential. Each of the credential manufacturing devices 104 is configured for data communication with the server 106, such as through the network connection 108, for example.

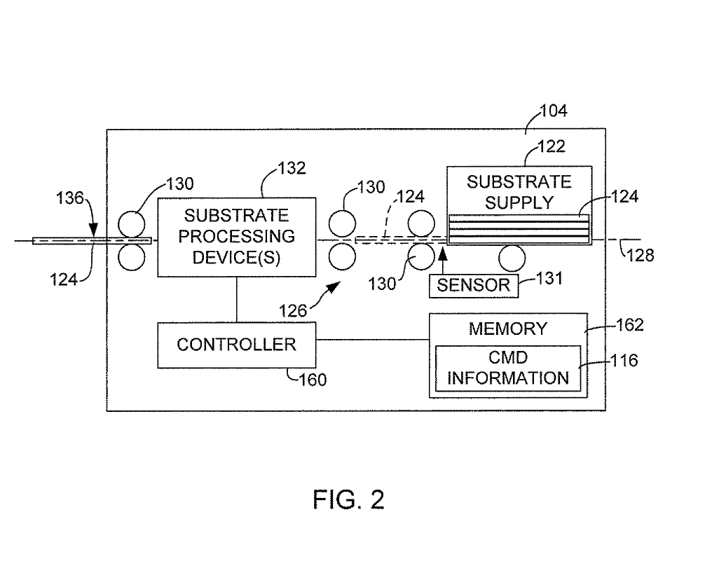

FIG. 2 is a simplified diagram of a credential manufacturing device 104 in accordance with embodiments of the invention. One embodiment of the credential manufacturing device 104 includes a substrate supply 122 that is configured to hold a plurality of credential substrates 124, such as plastic card substrates, paper substrates and other credential substrates. A substrate transport mechanism 126 is configured to feed individual substrates along a processing path 128. The substrate transport mechanism 126 can include, for example, motor-driven rollers including pinch roller assemblies, such as assemblies 130, or other substrate feeding components designed to feed an individual substrate 124 from the supply 122 along the processing path 128. One embodiment of the credential manufacturing device 104 includes a substrate sensor 131 configured to detect the feeding of a substrate 124 from the supply 122.

In accordance with one embodiment, the credential manufacturing device 104 is in the form of an identification card printer that processes plastic card substrates 124 in accordance with the credential production job to form an identification card. The plastic card substrates are rigid or semi-rigid substrates 124 that are susceptible to damage from excessive bending. As a result, one embodiment of the transport mechanism 126 is designed to avoid such bending of the card substrate 124 as it is fed along the processing path 128. In one embodiment, the processing path 128 is substantially flat, as illustrated in FIG. 2. That is, the processing path 128 may contain slight bends that do not damage the plastic card substrates 124, but lacks the significant bends of paper sheet feed mechanisms used in conventional paper sheet printers and copiers. Accordingly, those skilled in the art of credential manufacturing devices used to process the plastic card substrates 124 to form identification cards or credit cards understand that the transport mechanism 126 of the present invention differs substantially from paper sheet feed mechanisms of paper sheet printers and copiers, that transport paper sheets and other highly malleable substrates through a path that includes many bends that are unsuitable for the plastic substrates 124 used by the identification card printer embodiment of the credential manufacturing device 104 of the present invention.

One embodiment of the credential manufacturing device 104 includes at least one substrate processing device 132 configured to process the individual substrates 124. While these processing devices 132 will be discussed with reference to the processing of plastic card substrates used to form identification cards or credit cards, it is understood that that the substrate processing devices 132 described herein can be used to process the other types of credential substrates mentioned above.

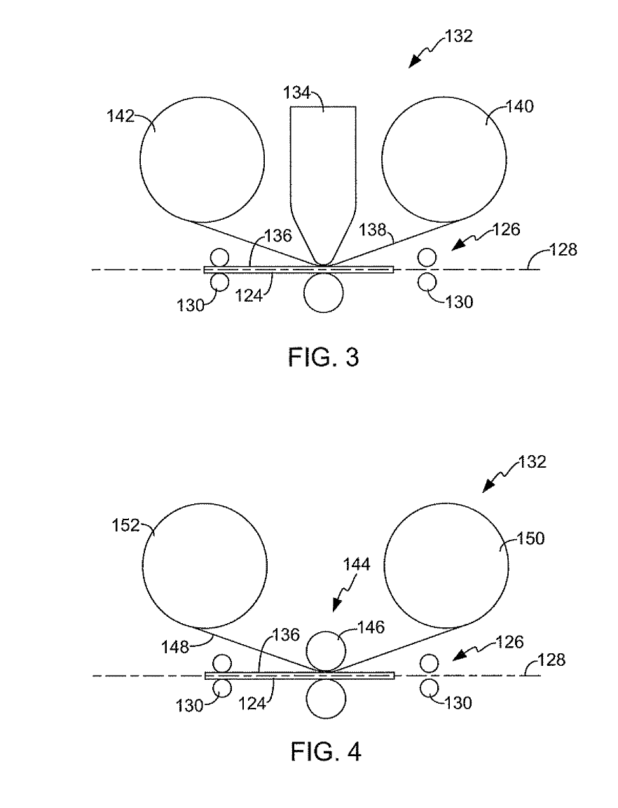

One embodiment of the substrate processing device 132 includes a print head 134, illustrated schematically in FIG. 3, that is configured to print an image to a surface, such as top surface 136, of the plastic card substrate 124 that is delivered along the processing path 128 by the transport mechanism 126. The print head 134 can be any conventional print head used in credential manufacturing devices 104. In accordance with one embodiment, the print head and the processing device includes a thermal print ribbon 138 wound between a supply spool 140 and a take-up spool 142. In one embodiment, the print ribbon 138 comprises panels of different colored dye (e.g., cyan, magenta, yellow, black). In accordance with this embodiment, the print head 134 applies heat and pressure to the print ribbon 138 and surface 136 to cause they dye to sublimate into the surface 136 of the substrate 124. Exemplary print heads of credential manufacturing devices are described in U.S. Pat. Nos. 7,154,519 and 7,018,117 and U.S. application Ser. No. 10/647,666, each of which are incorporated herein by reference in their entirety.

Another embodiment of the substrate processing device 112 includes a laminator 144, such as that illustrated in the simplified diagram of FIG. 4. The laminator 144 comprises a laminating roller 146 that is configured to apply heat and pressure to an overlaminate film 148 and the surface 136 of the substrate 124, such as surface 114, to laminate the overlaminate film 148, or an overlaminate patch, to the surface 136 of the substrate 124 that is in the processing path 128. The overlaminate film 148 can be wound between a supply roll 150 and a take-up roll 152.

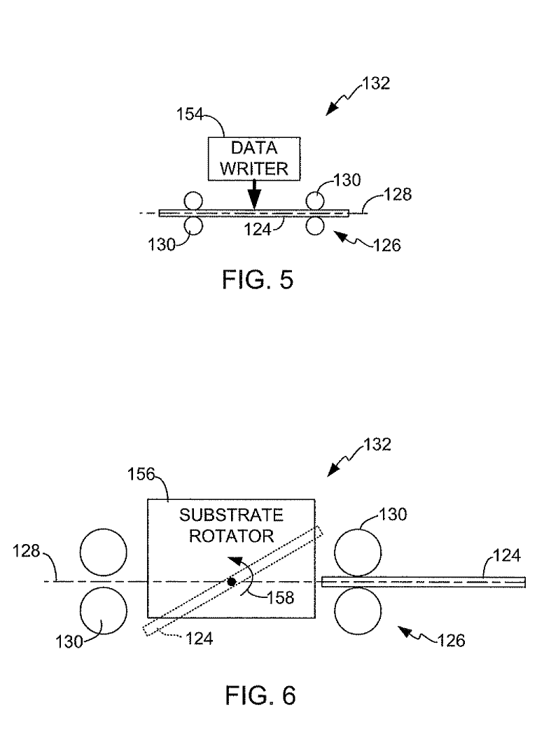

Another embodiment of the substrate processing device 132 includes a data writer or encoder 154, shown schematically in FIG. 5. The data writer 154 is configured to read and/or write data to the substrate 124. Exemplary data writers or encoders 154 include a magnetic stripe writer that is configured to write data to a magnetic stripe of the card substrate 124, a smart card writer that is configured to write data to memory of a smart card chip of the card substrate 124 either wirelessly or through direct contact, and other data writers of card manufacturing devices.

Another embodiment of the substrate processing device 132 includes a substrate rotator 156, a simplified illustration of which is provided in FIG. 6. The substrate rotator 156 is configured to rotate a substrate 124 to one or more indexed angular positions, as indicated by arrow 158. In one embodiment, the substrate rotator 156 is configured to invert the substrate 124. The inversion of a substrate 124 using the rotator 156 can take place after one side of the substrate 124 has been processed by another of the substrate processing devices 132 of the credential manufacturing device 104. This allows both sides of the substrate 124 to be processed. For example, an image can be printed to one side of the substrate 124 using the print head 134. Following the printing operation, the substrate 124 can be fed into the substrate rotator 156. After inverting the substrate 124 using the rotator 156, the substrate 124 can be fed back to the print head 134 to print an image on the side opposing the previously printed image. An exemplary substrate rotator is described in U.S. patent application Ser. No. 11/222,505 filed Sep. 8, 2005, which is hereby incorporated herein by reference in its entirety.

One embodiment of the credential manufacturing device 124 includes one or more controllers, represented in FIG. 2 as controller 160. The controller 160 operates to control the operation of the credential manufacturing device 104 including, receiving signals from sensors (e.g., sensor 131), controlling the credential processing devices 132, the transport mechanism 126 and other components of the credential manufacturing device 104.

The controller 160 also represents the components (e.g., microprocessor) used for network data communications, such as with the server 106. Additionally, the controller 160 is configured to process credential production jobs received from the server 106. Program instructions for processing the credential production jobs are stored in a tangible medium, such as memory 162, and are executable by the controller 160.

Embodiments of the credential production server 106 generally include a data store 170, which represents one or more tangible and computer-readable mediums and a server application 174 contained in the data store 170. The server application 174 includes instructions that are executable by a microprocessor (not shown) to perform steps of the methods described below.

In one embodiment, the server 106 is configured to receive the credential manufacturing device information 116i-n from each of the credential manufacturing devices 104i-n and store the credential manufacturing device information 116i-n, or select portions thereof, in the data store 170, as represented by credential manufacturing device information 176i-n. The credential manufacturing device information 176i-n corresponding to the credential manufacturing devices 104i-n in the system 100 can be stored as credential manufacturing device profiles 180 in the data store 170. In one embodiment the credential manufacturing device information 116i-n and 176i-n include model names for the corresponding credential manufacturing devices 104i-n, that identify type or model, as discussed above.

In one embodiment, the server 106 is configured to perform the method of managing the credential production jobs illustrated in the flowchart of FIG, 7. At step 200, the server 106 receives a credential production job from one of the client computers 102. In one embodiment, the credential production job defines one or more processes to be performed on a credential substrate 124, such as those discussed above. In one embodiment, the server 106 queues the received credential production jobs in one or more tangible storage mediums, represented by the queued jobs 204 in the data store 170.

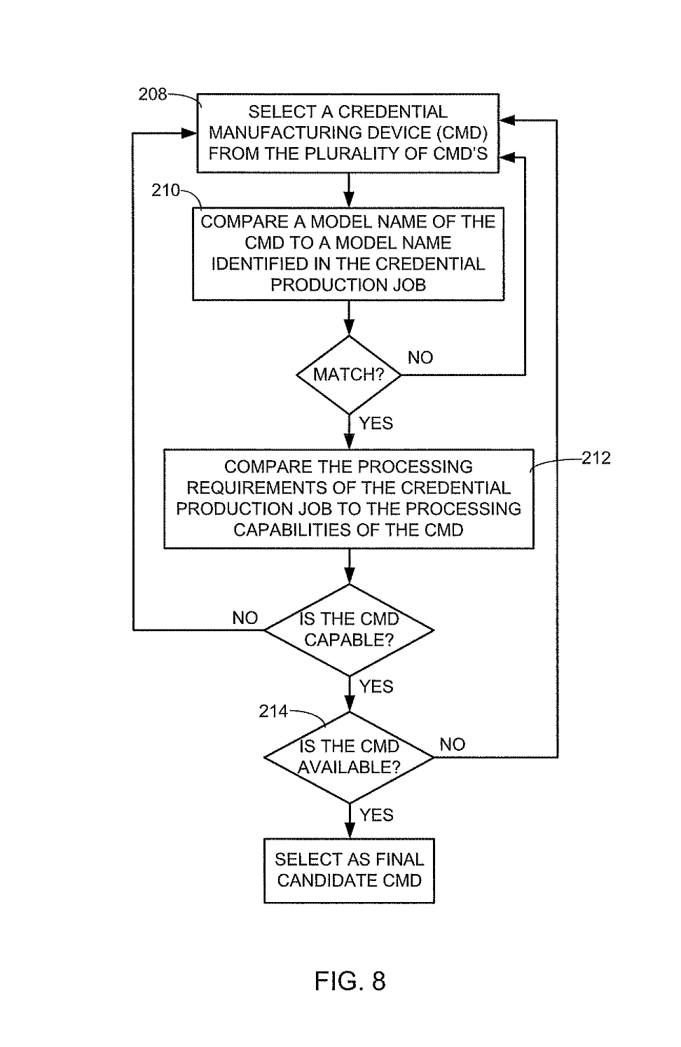

At step 206, a final candidate credential manufacturing device 104 is selected among the credential manufacturing devices that are capable of processing the credential production job. Embodiments of selecting step 206 will be discussed with reference to the flowchart of FIG. 8. In one embodiment of step 206, a candidate credential manufacturing device 104 is selected from the plurality of credential manufacturing devices 104i-n, at step 208. This generally involves selecting or analyzing one of the credential manufacturing device profiles or information 216i-n in the data store 170.

In one embodiment, the capability of the credential manufacturing devices 104 is determined, at least in part, based on the model name of the candidate credential manufacturing devices 104. This is due to the design of the various models of credential manufacturing devices 104. Typically, each model of credential manufacturing device 104 has a standardized manner of handling at least one function of the device. For example, one model of credential manufacturing device 104 will have the capability of performing the same printing process as the other credential manufacturing devices of the same model because they possess the same print head 134 and type of ribbon 138, the same credential production job data requirements, etc., but they do not possess the same printing capability as other models of credential manufacturing devices 104. That is, other models of credential manufacturing devices 104 may use a different print head 134, require different print head settings, use a different type of print ribbon 138, and/or have different credential production job data requirements (e.g., format and raw data requirements), for example.

Accordingly, in one embodiment, the model name identified in the credential production job is compared to the model name of the selected credential manufacturing device 104, at step 210. The model name of the candidate or selected credential manufacturing device 104 can be obtained from the credential manufacturing device information 176 for the device that is stored in the credential manufacturing device profiles 180. If the model name of the selected credential manufacturing device 104 does not match the model name identified in the credential production job, the method can return to step 208 where another candidate credential manufacturing device 104 is selected. If the model name of the selected credential manufacturing device 104 matches the model name identified in the credential production job, the selected credential manufacturing device 104 can be selected as the final candidate credential manufacturing device in step 206, or at least remain a candidate credential manufacturing device until other embodiments of step 206 described herein are performed.

While the credential manufacturing devices 104 having the same model name may possess some similar substrate processing capabilities, they can also possess different substrate processing capabilities from each other based on their hardware configuration and supplies. For example, one credential manufacturing device 104 may have a substrate rotator 156 thereby allowing for dual-sided processing of a credential substrate 124 whereas another credential manufacturing device, of the same model, may not possess a substrate rotator 156. Other differences that may exist between credential manufacturing devices 104 of the same model number include, for example, different types of print ribbon 138, different types of credential substrates 124 (e.g., different sized plastic cards) the possession of a data writer 154 or a different type of data writer 154 (e.g., a magnetic stripe data writer, smart chip encoder, RFID encoder, etc.), the possession of a laminator 144 and different types of overlaminate ribbon 148. Other differences can relate to the amount of consumables available to the credential manufacturing devices 104 of the same model, such as the amount of remaining print ribbon 138, the amount of remaining overlaminate ribbon 148 and the number of remaining credential substrates 124. In one embodiment, the server 106 acquires the information that is necessary to determine the processing capabilities of the candidate credential manufacturing devices 104i-n from the corresponding credential manufacturing device information 176i-n.

Embodiments of the step 206 include determining whether the candidate credential manufacturing device 104 is capable of processing the credential production job based on a determination of whether the candidate or selected credential manufacturing device 104 possesses the ability to perform all of the processes on the substrate 124 that are required or defined by the credential production job. This is generally accomplished by the server 106 through a comparison of the processing requirements (i.e., processing instructions and/or hardware requirements) defined in the credential production job to the processing capabilities of the candidate credential manufacturing device 104, as indicated at step 212. In one embodiment, this involves a comparison of the processing requirements of the credential production job to the processing capabilities of the candidate credential manufacturing device 104 described in the corresponding credential manufacturing device information 176. If the selected or candidate credential manufacturing device 104 possesses the capability to process the credential production job, then it can be selected as the final candidate credential manufacturing device in step 206, or at least remain a candidate credential manufacturing device 104 (i.e., remain a candidate until other embodiments of step 206 described herein are performed).

In one embodiment of step 212, the credential production job defines an inversion process to be performed on a credential substrate 124. Accordingly, one embodiment of step 212 comprises identifying whether the selected credential manufacturing device 104 includes a substrate rotator 156 that is configured to perform the inversion process through, for example, a check of the credential manufacturing device information 176 for the selected credential manufacturing device 104. If the selected credential manufacturing device 104 does not include a substrate rotator 156 configured to perform the inversion process, the method can return to step 208 where another of the credential manufacturing devices 104i-n is selected. If the selected credential manufacturing device 104 includes the required substrate rotator 156, the credential manufacturing device can be selected as the final candidate credential manufacturing device in step 206, or at least remain a candidate credential manufacturing device.

In one embodiment the credential production job defines a lamination process to be performed on a credential substrate 124. Accordingly, one embodiment of step 212 comprises identifying whether the selected credential manufacturing device 104 includes a substrate laminator 144 that is configured to perform the lamination process through, for example, a check of the credential manufacturing device information 176 for the selected credential manufacturing device 104. If the selected credential manufacturing device 104 does not include a substrate laminator 144 configured to perform the lamination process, the method can return to step 208 where another of the credential manufacturing devices 104i-n is selected. If the selected credential manufacturing device 104 includes the required substrate laminator 144, the credential manufacturing device 104 can be selected as the final candidate credential manufacturing device in step 206, or at least remain a candidate credential manufacturing device.

In one embodiment the credential production job defines a data writing process to be performed on a credential substrate 124. Accordingly, one embodiment of step 212 comprises identifying whether the selected credential manufacturing device 104 includes a data writer 154 that is configured to perform the data writing process through, for example, a check of the credential manufacturing device information 176 for the selected credential manufacturing device 104. If the selected credential manufacturing device 104 does not include a data writer 154 configured to perform the data writing process, the method can return to step 208 where another of the credential manufacturing devices 104i-n is selected. If the selected credential manufacturing device 104 includes the required data writer 154, the credential manufacturing device 154 can be selected as the final candidate credential manufacturing device in step 206, or at least remain a candidate credential manufacturing device.

In one embodiment, the credential production job defines a printing process to be performed on a credential substrate 124. Accordingly, one embodiment of step 212 comprises identifying whether the selected credential manufacturing device 104 includes a print ribbon 138 (i.e., certain type of print ribbon) that is configured to perform the printing process through, for example, a check of the credential manufacturing device information 176 for the selected credential manufacturing device 104. If the selected credential manufacturing device 104 does not include a print ribbon 138 configured to perform the printing process, the method can return to step 208 where another of the credential manufacturing devices 104i-n is selected. If the selected credential manufacturing device 104 includes the required print ribbon 138, the credential manufacturing device 104 can be selected as the final candidate credential manufacturing device in step 206, or at least remain a candidate credential manufacturing device.

In accordance with another embodiment of step 206, a determination is made as to whether the candidate credential manufacturing device 104 is available to process the credential production job as indicated at step 214 (FIG. 8). In one embodiment, this determination is made by the server 106 through a check of the current status of the candidate credential manufacturing device 104. If the candidate credential manufacturing device 104 is currently processing a credential production job or is otherwise unavailable (e.g., offline), it will be determined to be unavailable and the method can return to step 208 where another candidate credential manufacturing device 104 is selected. Alternatively, this step can be performed after all candidate credential manufacturing devices 104 have been determined based on one or more of the embodiments of step 206 described above, in which case, the next candidate credential manufacturing device 104 can be checked to determine whether it is available to process the job. If the candidate credential manufacturing device 104 is determined to be available, the candidate credential manufacturing device 104 can be selected as the final candidate credential manufacturing device in step 206, or at least remain a candidate credential manufacturing device.

It is generally desirable to balance the credential production job processing loads that are placed on a group of credential manufacturing devices 104i-n. In one embodiment of step 214, the determination of the availability of a candidate credential manufacturing device 104 to process the credential production job is based on how recently it last processed a credential production job, relative to the other credential manufacturing devices in the group. That is, candidate credential manufacturing devices 104 that haven't processed a credential production job recently will be designated “more available” than the candidate credential manufacturing devices 104 s that have processed a credential production job recently. In one exemplary embodiment, a candidate credential manufacturing device 104 that processed a credential production job more recently will be given a lower availability score those having processed a credential production job less recently. The candidate credential manufacturing device 104 of the group that has the highest availability score is then selected as the final candidate credential manufacturing device 104 in step 206.

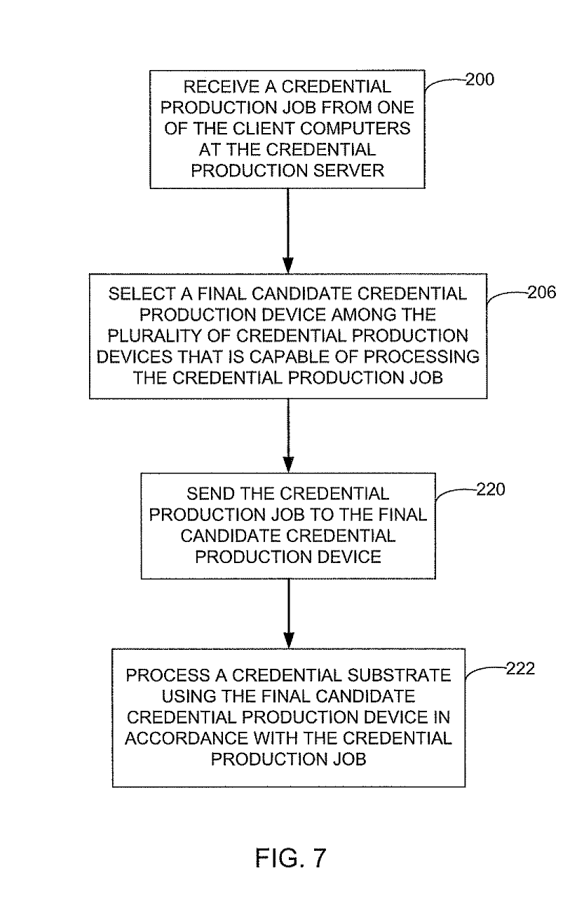

Once the final candidate credential manufacturing device is selected based on one or more of the above-described embodiments of step 206, the credential production job is sent to the final candidate credential manufacturing device 104, as indicated at step 220 (FIG. 7). Finally, a credential substrate 124 is processed, at step 222, using the final candidate credential manufacturing device 104 in accordance with the credential production job.

Additional embodiments of the invention are directed to managing the credential manufacturing device information 116 of the credential manufacturing devices 104. As discussed above, a user of one of the client computers 102 can access credential manufacturing device information relating to one of the credential manufacturing devices 104 using the driver program 112 of the client computer 102. However, rather than accessing the credential manufacturing device information 116 stored in memory of a particular credential manufacturing device 104 directly, the user is allowed access to the credential manufacturing device information 176 maintained in the data store 170 by the server 106.

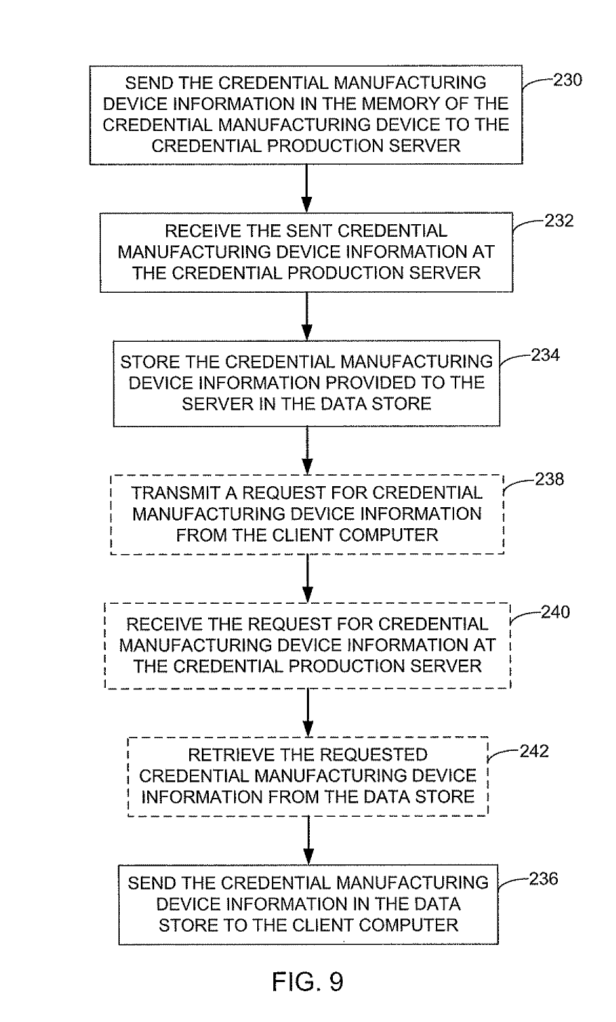

FIG. 9 is a flowchart illustrating a method of managing credential manufacturing device information 116 in the credential production system 100. As with the other methods described above, this method can be performed by an application or program module, such as the server application 174. That contains instructions stored in a tangible medium and executable by a microprocessor or computer.

At step 230 of the method, the credential manufacturing device information 116 stored in the memory of the credential manufacturing device 104 is sent to the credential production server 106. This process of sending the credential manufacturing device information 116 to the server 106 can be performed in response to a request for the information submitted to the credential manufacturing device 104 by the server 106, which in turn may be made in response to a request for such information from one of the client computers 102. Alternatively, the credential manufacturing device information 116 may be automatically sent to the credential production server 106 at regular intervals or following the processing of a credential production job.

At step 232, the sent credential manufacturing device information 104 is received by the credential production server 106. The credential manufacturing device information is then stored, at step 234, in the data store 170 as credential manufacturing device information, generally referred to as 176. Finally, at step 236, the credential manufacturing device information 176 in the data store 170 is sent to the client computer 102. Once the information 176 is received by the client computer 102, the driver program 112 can display the information to the user in accordance with conventional methods.

In accordance with one embodiment of the method, step 236 is performed in response to a request for the credential manufacturing device information that is sent to the server 106 by the driver program 112, as indicated at step 238. At step 240, the request for credential manufacturing device information is received at the credential production server 106. The requested credential manufacturing device information 176 is then retrieved from the data store 170 at step 242. Finally, the credential manufacturing device information 176 is sent to the client computer 102 at step 236.

As the credential manufacturing devices 104 process credential production jobs, the corresponding credential manufacturing device information 116 may change. For example, the amount of consumable supplies (print ribbon, credential substrates, over laminate film, etc.) that is available to the credential manufacturing devices 104 will change as a result of use of those supplies to process the credential production jobs. Additionally, the configuration of the credential manufacturing devices 104 may also change over time due to modifications performed by an administrator of the system 100. For example, the print ribbon 138 of a credential manufacturing device 104 may be changed to another type of print ribbon, the type of credential substrates 124 stored in the supply 122 may be changed and the type of over laminate film 148 in the credential manufacturing device 104 may be changed, for example. Additionally, changes may be made to the hardware of the credential manufacturing devices 104 including the removal, installation or replacement of a data writer 154, a substrate rotator 156, a laminator 144, a print head 134 or other credential processing device 132.

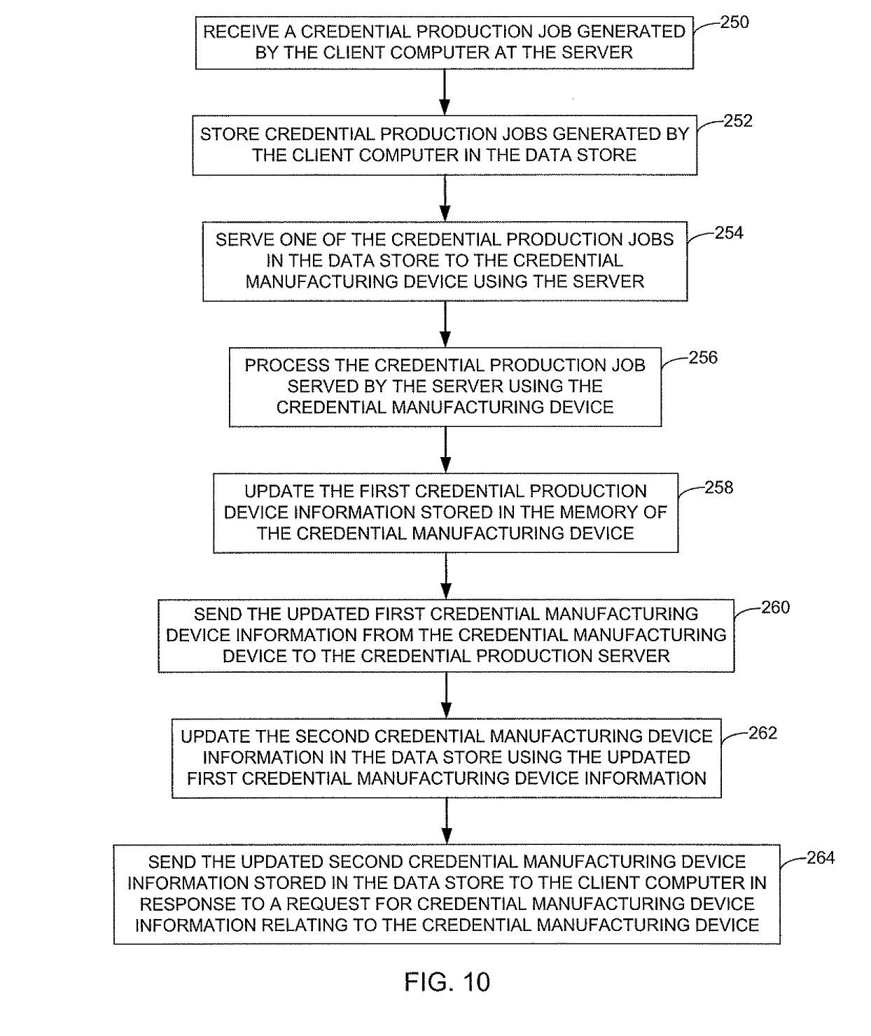

FIG. 10 is a flowchart illustrating a method by which the credential manufacturing device information 176i-n stored in the data store 170 of the server 106 is periodically updated for transmission to the client computers 102. At step 250, credential production jobs generated by the client computers 102 are received at the server 106 (queued jobs 204). The credential production jobs are then stored in the data store 170, at step 252. At step 254, the server 106 serves one of the credential production jobs in the data store 170 to the credential manufacturing device 104. The selection of the particular credential manufacturing device 104 that is to receive the credential production job may be determined in accordance with the embodiments described above. For this example, credential manufacturing device 104i will be chosen as the device to process the credential production job.

At step 256, the credential production job served in step 254 is processed by the credential manufacturing device 104i. At step 258, the credential manufacturing device information 116 stored in the memory of the credential manufacturing device 104i is updated. This update generally involves adjusting the remaining amount of consumable materials that are available to the credential manufacturing device 104i based on the use of those materials during the processing of the credential production job. Accordingly, this update may involve the reduction to the amount of print ribbon 138, the number of credential substrates 124, the amount of over laminate film 148, etc., provided in the credential manufacturing device information 116 for the device 104i prior to the processing of the credential production job.

The updated credential manufacturing device information 116 corresponding to the credential manufacturing device 104i is then sent to the credential production server 106. The server 106 then updates the credential manufacturing device information 176i in the data store 170 that corresponds to the credential manufacturing device 104i, at step 262. Finally, the updated credential manufacturing device information 176i stored in the data store 170 is sent to the client computer 102, at step 264. In one embodiment, the updated credential manufacturing device information 176i is sent to the client computer 102 after the server 106 receives a request for the information relating to the credential manufacturing device 104i, as discussed above.

Although the present invention has been described with reference to preferred embodiments, workers skilled in the art will recognize that changes may be made in form and detail without departing from the spirit and scope of the invention. For example, it should be understood that the present invention includes the embodiments described above taken individually and in combination with one or more of the other embodiments of the invention.

What is claimed is:

1. In a credential production system comprising a plurality of client computers, a plurality of credential manufacturing devices, and a credential production server that is remote from the client computers and the credential manufacturing devices, a method of managing credential production jobs generated by the client computers comprising:
receiving a credential production job from one of the client computers at the credential production server, wherein the credential production job defines one or more processes to be performed on a credential substrate;
selecting a final candidate credential manufacturing device among the plurality of credential manufacturing devices that is capable of processing the credential production job;
sending the credential production job to the final candidate credential manufacturing device; and
processing a credential substrate using the final candidate credential manufacturing device in accordance with the credential production job.

2. The method of claim 1, wherein selecting a final candidate credential manufacturing device comprises:
comparing model names of the plurality of credential manufacturing devices to a model name identified in the credential production job; and
selecting one of the plurality of credential manufacturing devices whose model name matches the model name identified in the credential production job as the final candidate credential manufacturing device.

3. The method of claim 1, wherein selecting a final candidate credential manufacturing device comprises:
comparing model names of the plurality of credential manufacturing devices to a model name of the credential production job; and
identifying each of the credential manufacturing devices whose model names match the model name identified in the credential production job as candidate credential manufacturing devices;
determining which of the candidate credential manufacturing devices is not currently processing a credential production job; and
selecting one of the candidate credential manufacturing devices that is not currently processing a credential production job as the final candidate credential manufacturing device.

4. The method of claim 1, wherein:
the credential production job defines an inversion process to be performed on a credential substrate; and
selecting a final candidate credential manufacturing device comprises identifying one of the plurality of credential manufacturing devices comprising a substrate rotator configured to perform the inversion process, as the final candidate credential manufacturing device.

5. The method of claim 1, wherein:
the credential production job defines a lamination process to be performed on a credential substrate; and
selecting a final candidate credential manufacturing device comprises identifying one of the plurality of credential manufacturing devices comprising a substrate laminator configured to perform the lamination process, as the final candidate credential manufacturing device.

6. The method of claim 1, wherein:
the credential production job defines a data writing process to be performed on a credential substrate; and
selecting a final candidate credential manufacturing device comprises identifying one of the plurality of credential manufacturing devices comprising a data writer configured to perform the data writing process, as the final candidate credential manufacturing device.

7. The method of claim 1, wherein:
the credential production job defines a printing process to be performed on a credential substrate; and
selecting a final candidate credential manufacturing device comprises identifying one of the plurality of credential manufacturing devices comprising a print ribbon configured to perform the printing process, as the final candidate credential manufacturing device.

8. A credential production system comprising:
a plurality of credential manufacturing devices;
at least one client computer; and
a credential production server that is remote from the client computer and the credential manufacturing device, the credential production server comprising instructions stored in a tangible medium and executable by a microprocessor for performing steps of:
receiving a credential production job from one of the client computers at the credential production server, wherein the credential production job defines one or more processes to be performed on a credential substrate;
selecting a final candidate credential manufacturing device among the plurality of credential manufacturing devices that is capable of processing the credential production job; and
sending the credential production job to the final candidate credential manufacturing device for processing.

9. The system of claim 8, wherein the instructions for selecting a final candidate credential manufacturing device comprise instructions for:
comparing model names of the plurality of credential manufacturing devices to a model name identified in the credential production job; and
selecting one of the plurality of credential manufacturing devices whose model name matches the model name identified in the credential production job as the final candidate credential manufacturing device.

10. The method of claim 8, wherein the instructions for selecting a final candidate credential manufacturing device comprise instructions for:
comparing model names of the plurality of credential manufacturing devices to a model name of the credential production job; and
identifying each of the credential manufacturing devices whose model names match the model name identified in the credential production job as candidate credential manufacturing devices;
determining which of the candidate credential manufacturing devices is not currently processing a credential production job; and
selecting one of the candidate credential manufacturing devices that is not currently processing a credential production job as the final candidate credential manufacturing device.

11. The system of claim 8, wherein:
the credential production job defines an inversion process to be performed on a credential substrate; and
the instructions for selecting a final candidate credential manufacturing device comprise identifying one of the plurality of credential manufacturing devices comprising a substrate rotator configured to perform the inversion process, as the final candidate credential manufacturing device.

12. The system of claim 8, wherein:
the credential production job defines a lamination process to be performed on a credential substrate; and
the instructions for selecting a final candidate credential manufacturing device comprise identifying one of the plurality of credential manufacturing devices comprising a substrate laminator configured to perform the lamination process, as the final candidate credential manufacturing device.

13. The system of claim 8, wherein:
the credential production job defines a data writing process to be performed on a credential substrate; and
the instructions for selecting a final candidate credential manufacturing device comprise identifying one of the plurality of credential manufacturing devices comprising a data writer configured to perform the data writing process, as the final candidate credential manufacturing device.

14. A credential production system comprising:
a plurality of identification card printers each comprising a supply of plastic card substrates, a card transport mechanism, a print ribbon and a print head configured to transfer dye from the print ribbon to a surface of individual plastic card substrates fed from the supply by the card transport mechanism;
at least one client computer;
a credential production server that is remote from the client computer and the credential manufacturing device, the credential production server comprising instructions stored in a tangible medium and executable by a microprocessor for performing steps of:
receiving a credential production job from one of the client computers at the credential production server, wherein the credential production job defines one or more processes to be performed on a plastic card substrate;
selecting a final candidate identification card printer among the plurality of identification card printers that is capable of processing the credential production job; and
sending the credential production job to the final candidate identification card printer for processing.

15. The system of claim 14, wherein:
the credential production job defines an inversion process to be performed on a plastic card substrate; and
the instructions for selecting a final identification card printer comprise identifying one of the plurality of identification card printers comprising a substrate rotator configured to perform the inversion process, as the final candidate credential manufacturing device.

16. The system of claim 14, wherein:
the credential production job defines a lamination process to be performed on a plastic card substrate; and
the instructions for selecting a final identification card printer comprise identifying one of the plurality of identification card printers comprising a laminator configured to perform the lamination process, as the final candidate identification card printer.

17. The system of claim 14, wherein:
the credential production job defines a data writing process to be performed on a plastic card substrate selected from the group consisting of writing data to a memory chip of a plastic card substrate and writing data to a magnetic stripe of a plastic card substrate; and
the instructions for selecting a final identification card printer comprise identifying one of the plurality of identification card printers comprising a data writer configured to perform the data writing process, as the final candidate identification card printer.

18. The system of claim 14, wherein the instructions for selecting a final identification card printer comprise identifying one of the plurality of identification card printers that is not currently processing a credential production job, as the final candidate identification card printer.

19. The system of claim 14, wherein the instructions for selecting a final candidate identification card printer comprise instructions for:
comparing model names of the plurality of identification card printers to a model name identified in the credential production job; and
selecting one of the plurality of identification card printers whose model name matches the model name identified in the credential production job as the final candidate identification card printer.

20. The method of claim 14, wherein the instructions for selecting a final candidate identification card printer comprise instructions for:
comparing model names of the plurality of identification card printers to a model name of the credential production job; and
identifying each of the identification card printers whose model names match the model name identified in the credential production job as candidate identification card printers;
determining which of the candidate identification card printers is not currently processing a credential production job; and
selecting one of the candidate identification card printers that is not currently processing a credential production job as the final candidate credential manufacturing device.
